(19) United States
(12) Patent Application Publication
(10) Pub. No.: US 2010/0030659 A1
(43) Pub. Date: Feb. 4, 2010

(54) Method for Facilitating Charitable Donations

(76) Inventor: Jeffrey Howard Epstein, Northbrook, IL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/185,100

(22) Filed: Aug. 3, 2008

(51) Int. Cl. G06Q 30/00

(52) U.S. Cl. 705/27; 705/1; 715/727

(57) ABSTRACT

Methods of facilitating charitable donations using the internet are provided. Charitable organizations may post a picture which has been divided into predetermined sections on the internet, with each section having a corresponding price associated therewith. Donors, upon paying the price for a desired section, may post an image, text or audio data in association with their purchased image section.

### FIELD OF THE INVENTION

The present invention pertains to methods and devices for facilitating the making of charitable donations.

### BACKGROUND OF THE INVENTION

Charities and the making of charitable donations for various causes and honors has been a part of mankind since the beginning of recorded history. Many individuals, groups and organizations attempt to raise money for various charitable causes by seeking donations from individuals, organizations, companies, or groups of individuals. Until not too long ago, one only knew of the charitable causes within one's own town or village. Within each village, everyone generally knew who was raising money and for what cause. Everyone also knew who the generous donors were, and this leant a certain stature to such donors within their villages which, among other things, may have allowed them to have a stronger voice in their communities.

Then as transportation and communication technologies expanded, charitable causes began to expand their reach. Many charitable organizations expanded nationally and others expanded more locally. The result has been that many charitable organizations rely on more distant donors, and that since many donors are donating their money to places far from their homes they are not getting the benefit of appreciation from others and the ability to influence others toward positive charitable work.

There is a need for improved methods and devices for carrying out the solicitation and structure for charitable donations which fulfills the above shortcomings.

There is also a need for novel methods of doing business to keep attracting donations in an increasingly competitive charitable environment.

### SUMMARY OF THE INVENTION

In accordance with one aspect of the present invention, a method of operating a charitable organization is provided in which an electronic copy of an image on the internet is provided, the image is divided into predetermined sections, with each predetermined section having a respective price assigned to it. The one or more sections are sold, and upon being sold selective electronic data is posted to the sold section. A predetermined portion of the sales income which is received from selling the image sections to donors is provided to a selective charity.

In accordance with another aspect of the present invention, an advertising section may be provided in association with the electronic copy of an image, and a fee charge to third party advertisers for posting advertising. The advertising section may remain posted as two or more different pictures from different charitable organizations are sold.

### DESCRIPTION OF THE DRAWINGS

For the purpose of facilitating understanding of the invention, the accompanying drawings and description illustrate preferred embodiments thereof, from which the invention, various embodiments of its method of operation and structure, and many advantages may be understood and appreciated.

FIG. 1, the sole figure, is an illustrative example of a picture divided into predetermined sections, with each of the sections having an associated purchase amount.

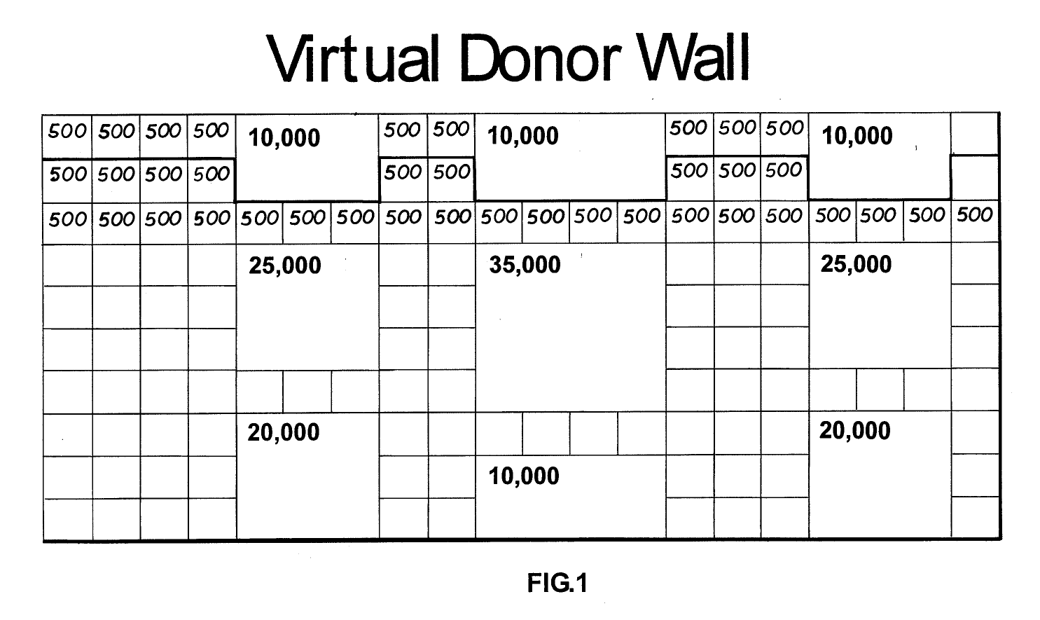

### DESCRIPTION OF THE PREFERRED EMBODIMENTS

The following description is provided to enable those skilled in the art to make and use the described embodiments set forth in the best modes contemplated for carrying out the invention. Various modifications, equivalents, variations, and alternatives, however, will remain readily apparent to those skilled in the art. Any and all such modifications, variations, equivalents, and alternatives are intended to fall within the sprit and scope of the present invention.

In accordance with the present invention, a method of conducting a charitable collection using the internet is provided. A donation facilitator posts an image (which may be an image representative of or otherwise associated with the charitable event but not necessarily) on the internet pursuant to a request by a charitable organization which is desirous of obtaining donations for a selective charity. The posted image is divided into a plurality of predetermined sections (which may or may not be contiguous), with each of the sections of the picture having a donation amount associated therewith.

Potential donors are directed to the internet site on which the picture is posted. This marketing to direct people to the internet site may be carried out by the charitable organization, the donation facilitator, both or third parties. Viewers of the posted image, such as viewing on a website to which they have been directed, may purchase one or more of the sections of the picture by paying the donation facilitator the associated donation amount for each respective picture section.

The donation facilitator then provides the donor with information, such as a password or the like, sufficient to allow the donor, or its representative, to attach a desired image to the purchased picture section. Upon attachment of a desired image to the purchased picture section by the donor, that image will become visible over the picure section to which it has been associated, and remain visible for subsequent people who access the website to see.

The donor may also be allowed to associate an audio file, moving picture file, or the like to their purchased picture section. In such instances, the audio file or moving picture file would come up and be visible/heard upon people pointing and clicking on the image which has been posted on the purchased picture section. This allows donors to honor a loved one with something sentimental, to make a political statement, make a motivating or encouraging statement appealing to others to donate, or the like. For instance, a celebrity, religious leader, or someone highly respective within a group or organization may make an initial donation or allow their image and message to be used in connection with a charitable event, and their encouraging statements may facilitate increased donations by people influenced by such a person.

The donation facilitator may charge a fee from the charitable organization, such as a percentage of donations obtained, or any of a wide variety of other ways of getting paid for the providing of services.

The manner in which the picture is divided may vary widely. It is not necessary to have the biggest sections of the picture cost the most. For instance, there may be a picture of a person in a large room, with the person being small in the picure relative to, say, the stage behind them which appears larger in the picture. Since most viewers will be drawn to the face of the person in the picture more than the stage, despite the fact that the stage is larger in the picture, the relatively smaller picture space of the person's face may be likely to prompt a larger donation than the relatively larger picture space of the stage, and hence this space may be offered at a higher donation price. There could be incentives provided for being one of the first donors, such as getting a lower cost for a given picture section, to prompt early donations.

In accordance with one aspect of the present invention, a self-service, multi-templated website may be provided to allow charitable organizations that want to raise funds a simple way to be able to create a unique and attractive appeal for donations. Such uniqueness may also attract new donors which were not otherwise timely reached.

In accordance with one aspect of the present invention, a large variety of templates and graphic tools may be made available to donors over the internet to allow the donors to create or customize their own photos or other artwork they intend to post. Or a selection of options such as religious symbols, university logos, or the like may be made available to donors.

In accordance with another aspect of the present invention, data and information may be collected from the donors, which the charity may use for various purposes, or which the donation facilitator may use for various purposes, such as email marketing campaigns or making personal contact with willing donors.

Multiple year donations may be made, with the stored data being used to make annual withdrawals. Much, if not all, of the donation process may be automated, with the receipts automatically tallied and processed for one or both the charitable organization and the donation facilitator. Software may be desiged in connection with the process to help manage the fundraising.

The picture which is used may be larger than a single computer screen, and may allow a user to scroll across multiple screens to view the entire picture. And a fundraising event may start as a picture which can be viewed in its entirety on a single computer screen, and then if the fundraising event proves to be very successful, additional contiguous picture space on additional screens may be subsequently added. Such picture space would likely be less expensive than picture space on the main screen area, but if the donations became large enough then numerous less expensive spaces could add up to significant contributions to the cause.

The present invention provides an inexpensive way to raise money and manage fundraising. Using the internet is far less expensive than traditional paper-based methods for small donations. Charities strive to keep the cost of their fundraising activities to a minimum, and the present invention provides a way for them to operate with low fundraising budgets.

Also, the fundraising method of the present invention takes advantage of the viral characteristics of the internet. Individuals can forward solicitations to friends and family with a personal note attached.

Another advantage of the fundraising method of the present invention is that collection of the payments may be done through a web-based payment service like PayPal or through credit cards, cutting down on collection problems and pledge fulfillment issues.

Another variation of methods for facilitating charitable donations is to provide an advertising section in association with the picture, with the advertising being paid by third pary advertisers. The third party advertising may be a permanent or semi-permanent display on a donation website, with various different charitable organizations posting respective images to the website when it is their opportunity to use the web site. The presence of the paid advertising may allow the donation facilitator or donation facilitating entity to charge a lower amount to the charitable organizations than they would otherwise charge, or allow them to charge nothing to the charitable organizations with the charitable organizations driving traffic to the internet serving to motivate advertisers to place their advertising on the site, whereby the donation facilitator gains increased advertising revenue which may allow the offering of free usage of the site or sites by charitable organizations.

The third party advertising may be along the side of the divided image sections being sold, surround the image, or be embedded within the image similar to a product placement in a movie.

It will be appreciated that while several of the illustrative embodiments are with reference to charitable organizations and functions, the invention may be applied to a wide variety of other businesses and operations.

The invention having been described herein by way of specific embodiments for representative purposes, it will be evident to those skilled in the art that numerous variations may be made without departing from the inventive concepts as defined in the appended claims, and equivalents thereto.

What is claimed is:

1. A method of operating a charitable organization, comprising:
providing an electronic copy of an image on the internet;
dividing the image into predetermined sections;
assigning a respecive price to each predetermined section;
selling one or more of said predetermined sections at its respective price;
posting selective electronic data to each of a respective one of said predetermined sections upon it being sold; and
passing on a predetermined portion of the sales income to a selective charity.

2. A method in accordance with claim 1 further comprising:
providing an advertising section in association with said electronic copy of an image;
charging a fee for posting of said advertising section in association with said electronic image.

3. A method in accordance with claim 2 in which the predetermined portion of the sales income is zero.

4. A method in accordance with claim 2 in which the advertising section remains posted as two or more different pictures from different charitable organizations are sold.

5. A method in accordance with claim 1 in which the selective electronic data comprises visual images.

6. A method in accordance with claim 1 in which the selective electronic data comprises audio sounds.

7. A method in accordance with claim 1 in which the selective electronic data comprises a visual image in the predetermined section which is seen by people accessing the internet site, and the audio sounds are audible upon pointing and clicking on the visual image.

8. A method of doing charitable business, comprising:
a donation facilitator providing an electronic copy of an image suitable for charitable functions on an internet site for a fee;
a charitable organization paying the fee, and dividing the image into predetermined sections, and providing respective donation amounts in association with each of said predetermined sections;
the charitable organization receiving the donation amounts and allowing the donors to post a desired image to their purchased predetermined image sections; and
the charitable organization paying a portion of the donations to the donation facilitator.

9. A method in accordance with claim 8 further comprising:
providing an advertising section in association with said electronic copy of an image; and
charging a fee for posting of said advertising section in association with said electronic image.

10. A method in accordance with claim 9 in which the predetermined portion of the sales income is zero.

11. A method in accordance with claim 8 in which the selective electronic data comprises visual images.

12. A method in accordance with claim 8 in which the selective electronic data comprises audio sounds.

13. A method in accordance with claim 8 in which the selective electronic data comprises a visual image in the predetermined section which is seen by people accessing the internet site, and the audio sounds are audible upon pointing and clicking on the visual image.

14. The method in accordance with claim 8 in which said selective electronic data comprises a replacement electronic image which is substituted for the predetermined electronic image section sold, and the electronic copy is updated so the respective substituted electronic images are visible over their respective purchased predetermined sections to all subsequent accessers.

15. The method in accordance with claim 13 in which said selective electronic data further comprises an electronic detail file which is associated with the respective sold sections and activated upon pointing and clicking of a user on the respective replacement electronic image.

16. A method of conducting charitable activities over an electronic network, comprising:
providing an initial electronic image over the electronic network;
offering selective, predetermined portions of said electronic image for sale; allowing the purchasers to replace the one or more portions of the electronic image which they purchase with a replacement electronic image of their choosing;
allowing the purchasers to associate an electronic detail file of their choosing with the one or more portions of the electronic image which they purchase;
making each of the replacement electronic images visible for all subsequent users; and
making each of the respective electronic detail files activate upon a user pointing and clicking on a replacement electronic image for all subsequent users.
